(19) United States
(12) Patent Application Publication
(10) Pub. No.: US 2025/0248459 A1
(43) Pub. Date: Aug. 7, 2025

(54) DEVICE FOR RELEASABLY CONNECTING GARMENTS

(71) Applicant: Leesa R. Frederick, Southfield, MI (US)

(72) Inventor: Leesa R. Frederick, Southfield, MI (US)

(21) Appl. No.: 18/434,586

(22) Filed: Feb. 6, 2024

(51) Int. Cl. A41B 11/00; F16B 5/06

(52) U.S. Cl. CPC A41B 11/002; F16B 5/06

(57) ABSTRACT

A clip device that can be used to releasably connect two or more articles that are composed of woven, non-woven, or knitted fabric that includes a first planar member and a second planar member that is movably connected to the first planar member each having a heat resistant polymeric material adhering thereto. The clip device also includes a pivotal attachment mechanism connected to the first and second planar metal members. The pivotal attachment mechanism can include at least one biasing member. At least one prong projects from the inwardly oriented face of an associated planar member and is releasably connected to a connection member defined in the opposed planar member.

### BACKGROUND

The present disclosure relates devices for use with woven or non-woven fabric artless articles such as articles of clothing. More particularly, the present disclosure relates to devices that can be employed to connect two or more garments or other woven, non-woven, and/or knitted articles. The present disclosure also pertains to methods of storage and maintenance of such articles including, but not limited to, cleaning, storage, and various other uses.

Various woven, non-woven, and/or knitted articles exist as units that are used, stored, or maintained in mated groups of two or more. Non-limiting examples of such articles include socks, gloves, and the like. From time to time, such articles need to be laundered and/or stored and are at risk of being separated. When one of the units is lost or separated from its pair, the value of the garment decreases. While this can be true for any user, in certain instances, it seems that the incidence of losing one article of a pair occurs more often with children.

There is also a need to empower children and others in the care and organization of their environment and possessions. This can be accomplished is in the organization and care of personal clothing including mated articles such as socks. The use of clips and connection devices has been proposed as a means for assisting individuals, young and old, in executing such tasks.

Various devices have been proposed that can be employed to connect various woven, non-woven and/or knitted articles such as socks to facilitate washing, drying and storage of mated groups or pairs. Many of these devices require modification of the garments in order to function. Use of other devices increases the risk that the articles connected by the device be distorted or damaged with use. Still others possess features that render them difficult to use or may be dangerous to the user, particularly the young user.

Thus, it would be desirable to provide a device that can be used by various individuals in a manner that minimizes the risk of damage to the associated clothing articles. It would also desirable to provide a device that does not require alteration of clothing articles to function. Further, it is desirable to provide a device that can be successfully used by a wide variety of users and/or can be employed as part of a routine to empower and/or educate individuals. It is also desirable to provide a device that is aesthetically pleasing.

### SUMMARY OF THE INVENTION

Disclosed herein is a clip device that can be used to releasably connect two or more articles that are composed of woven, non-woven, or knitted fabric, such as articles of clothing. The clip device includes a first planar member and a second planar member that is movably connected to the first planar member. The first and second planar members each have an outwardly oriented face or surface and an inwardly oriented face or surface. The outwardly oriented face of the first planar member and the outwardly oriented face of the second planar member each have at least one layer of a heat resistant polymeric material adhering thereto. Where desired or required, either the first planar member, the second planar member or both can be composed of a metal, a metal alloy or a metal-reinforced material.

The clip device also includes a pivotal attachment mechanism, configured such that the first and second planar metal members are connected to the pivotal attachment mechanism and project outward therefrom. The pivotal attachment mechanism can include at least one biasing member. The biasing member movable between a compressed position and an extended position such that the first planar metal member and the second planar metal member are oriented in overlying relationship when the biasing member is in the compressed position.

At least one of the first planar member or the second planar member includes at least one prong projecting from the inwardly oriented face of the associated planar member. The at least one prong is positioned at a location distal to the pivotal attachment mechanism. The at least one prong is configured to pierce and project through multiple layers of fabric associated therewith.

The clip device also includes a closure mechanism positioned at a location distal to the pivotal attachment mechanism. The closure mechanism has a prong-receiving opening and is configured to releasably receive the at least one prong member therein.

### BRIEF DESCRIPTION OF DRAWINGS

The various features, advantages and other uses of the present device will become more apparent by referring to the following detailed description and drawings in which:

FIG. 1 is a side plan view of the clip device in a closed position according to an embodiment as disclosed herein;

FIG. 2 is a side perspective view of the clip device of FIG. 1 in an open position;

FIG. 3 is a front cross section view taken through the 3-3 line of the clip device of FIG. 1;

FIG. 4A is a top view of the clip device of FIG. 1;

FIG. 4B is a bottom plan view of the clip device of FIG. 1;

FIG. 5 is a detail view of an embodiment of a pivot mechanism employed in the clip device as disclosed herein;

FIG. 6 is a detail view of FIG. 3 illustrating an embodiment of a closure mechanism as disclosed herein;

FIG. 7 is a cross-sectional view of the clip device taken through the 7-7 line of FIG. 1;

FIG. 8 is a schematic view of an embodiment of the clip device as disclosed herein with a pair of socks in the use position;

FIG. 9 is a cross-sectional detail view of an alternate embodiment of the closure mechanism employed with the clip device as disclosed herein;

FIG. 10 is a cross-sectional view taken through the 10-10 line of FIG. 9; and

FIG. 11 is cross-sectional view of an alternate embodiment of a first arm member of a clip device as disclosed herein.

### DETAILED DESCRIPTION

It is contemplated by this disclosure that there exists a need for clip devices that can be effectively employed to associate articles of clothing such as members of a pair of socks, particularly clip devices that can be employed in processes such as in the laundering, drying and/or storage of articles of clothing such as the pairs of socks.

As disclosed herein, there is a clip device includes first and second members that can effectively connect and contain textile articles such as articles of clothing, for example pairs of socks and the like during processes such as laundering, drying, storage, etc. Textile, as that term is employed herein, is taken to include woven, non-woven, and/or knitted material that can be composed of animal or plant-derived material, synthetic material, and/or mixtures thereof.

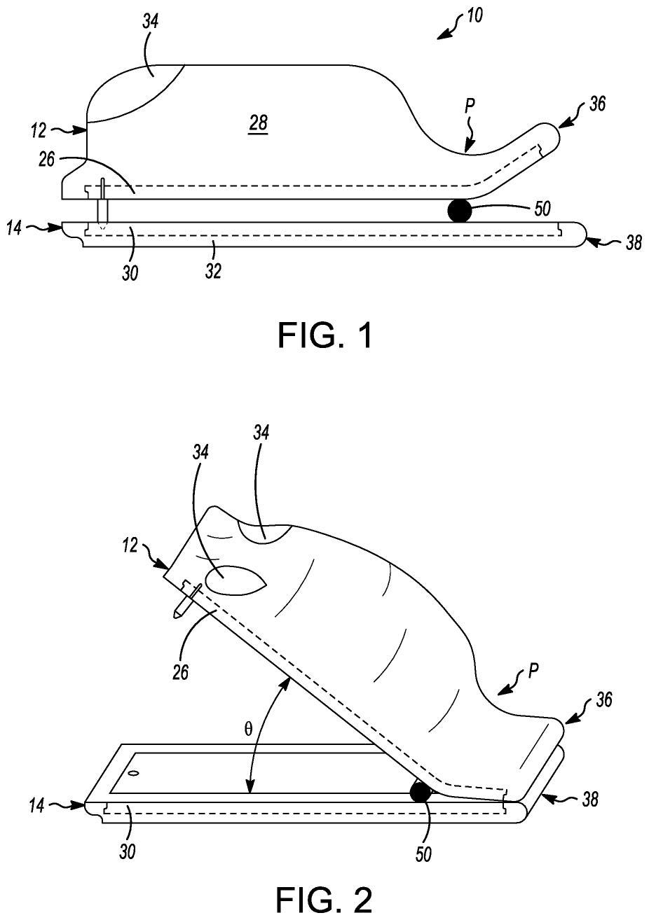

A non-limiting embodiment of the clip device as disclosed herein is illustrated in the various drawing figures. Turning to FIG. 1, a clip device 10. The clip device 10 includes a first arm member 12 and a second arm member 14 configured such that the first arm member 12 is pivotally movable relative to the second arm member 14. In certain embodiments, the first arm member 12 and second arm member 14 can be in overlying essentially parallel relationship with one another in a first position and can be movable between the first position in which the first member 12 and the second member 14 are positioned in the at least one overlying orientation such as that illustrated in FIG. 1 to a second position in which the first arm member 12 and the second arm member 14 are oriented to one another at a relationship other than parallel. A non-limiting embodiment of the non-parallel relationship between first arm member 12 and second arm member 14 in the second position as would occur when the device 10 is in an open position is illustrated in FIG. 2A.

The non-parallel orientation between the first arm member 12 and the second arm member 14 can define an angle θ that is sufficient to accommodate positioning and removal of the fabric articles associated with the clip device 10. In certain embodiments, the angle θ is greater than 10°. In certain embodiments, the angular orientation can have a value between 5° and 45°; between 5° and 300; between 5° and 200; between 5° and 150; between 5° and 10°. Means for limiting the travel of the respective first arm member 12 and second arm member 14 relative to one another to the value angle θ will be discussed subsequently.

The first arm member 12 and/or the second arm member 14 can include an outwardly oriented face and an inwardly oriented face. In the embodiment as illustrated in the various drawing figures, the first arm member 12 has a first arm inwardly oriented face 16 and a first arm outer surface 18 generally opposed to the first arm inwardly oriented face 16 and the second arm member 14 has a second arm member inwardly oriented face 20 and a second arm member outer surface 22 opposed to the second arm member inwardly oriented face 20.

In the embodiment as depicted in FIGS. 1, 2 and 3, the first arm member 12 can include a first arm member substrate layer 26 (shown in phantom in FIGS. 1 and 2). The first arm member 12 can include at least one first arm member heat-resistant layer 28 in overlying relationship to at least a portion of the first arm member substrate layer 26. The second arm member 14 can include a second arm member substrate layer 30 (shown in phantom in FIGS. 1 and 2). The second arm member 14 can include at least one second arm member heat-resistant layer 32 in overlying relationship to at least a portion of the first arm member substrate layer 30.

The respective first and second arm member substrate layers 26, 30 can be composed of a suitable rigid or semi-rigid material that is heat stable and water resistant. Non-limiting examples of suitable materials include various metals including stainless steel and the like. The respective substrate layers 26, 30 can have any suitable configuration. In certain embodiments, one or both of the arm member substrate layers 26, 30 can be configured as planar members. It is also considered to be within the purview of this disclosure that one or both of the substrate layers 26, 30 can be configured with a non-planar configuration such as being concave or partially concave. The respective first and second arm member substrate layers 26, 30 each define an outwardly facing surface and an opposed inwardly oriented surface. In certain embodiments, the inwardly oriented surface of the one or both of the respective first and second arm member substrate layers 26, 30 can define all or part of the inwardly oriented face 16, 20 if desired or required.

The respective first and/or second member substrate layers 26,30 can be configured to facilitate connection between the respective substrate layer and the associated heat resistant layer. Where desired or required, one of more of the first and/or second substrate layers 26, 30 can have one or more surface configurations suitable for assisting connection or adhesion of respective heat resistant layers. In certain embodiments, the surface configuration can be surface contours such as groves detents and the like. In certain embodiments, it is within the purview of this disclosure that the one or both of the first and/or second member substrate layers 26,30 can be configured with one or more apertures or openings that extend though the body of the associated arm substrate layer 26, 30. It is also considered to be with in the purview of this disclosure that the one or both of the substrate layers 26, 30 can have a combination of surface contours and apertures. Such surface contours, openings or apertures can be configured to receive suitable polymeric and/or adhesive material that can be employed in the device 10 as disclosed.

One or both of the respective heat-resistant layers 28, 32 can be composed of a suitable polymeric material that has an insulative characteristic. Suitable materials will be those that can adhere to the material employed in the respective substrate layers 26, 30. The respective heat-resistant layer 28, 32 can adhere directly to the associated substrate layer 26, 30, or can include one or more suitable material layers such as adhesives or bonding agents interposed therebetween as desired or required.

In certain embodiments, the heat resistant layer can be composed of a suitable heat-stable polymeric material that remains cool to the touch when the clip device 10 is exposed to elevated temperatures, such as would be employed in a clothes dryer or the like. The material of choice will be one that exhibits little or no off-gassing at elevated temperatures as would be found in a close drier and can maintain structural adhesion and integrity over multiple duty cycles. In certain embodiments the heat-stable polymeric material can be a polymeric silicone such as silicone rubber.

Non-limiting examples of suitable polymeric silicone include moldable rubber-like silicone or polysiloxanes. It is believed that such materials will be moldable and can exhibit resistance to elevated temperatures up to as high as 570° F. Any suitable polymeric silicone material with the stated heat-resistance and moldability properties can be used for the heat-resistant layers. Where desired or required, suitable materials include those that are classified as suitable for use in food contacting operation. Non-limiting examples of suitable silicone materials include materials such as one-component room temperature vulcanization silicone rubber such as RTV-1 silicone, two-component silicone materials such as RTV-2 silicones and the like. Without being bound to any theory, it is believed that RTV-1 silicones may be a mixture of polydimethylsiloxanes, cross-linking agents suitable to create a three-dimensional network, fillers and auxiliaries. It I believed that RTV-2 silicones comprise linear polymers, reinforcing mineral fillers or silicone resins and wells as optional cross-linkers catalysts and inhibitors to control pot life. It is within the purview of this disclosure to employ various cross-linkable silicone resins such as those commercially available from various sources such as Elkem.

The heat-resistant layers 28, 32 can each have a thickness sufficient to provide low heat conductivity through the respective layer from the associated substrate layer 26, 30. In certain embodiments, the thickness will be greater than 0.1 inch. In certain embodiments, the thickness can be between 0.1 and 1 inch. In certain embodiments, the thickness can be uniform or generally uniform along the surface of one or both of the associated substrate layers 26, 30.

One or both of the heat-resistant layers 28, 32 can be of constant or near-constant thickness in certain embodiments. It is also within the purview of this disclosure that one or more of the heat-resistant layers 28, 32 can be configured with a variable thickness across the body of the associated substrate layer 26, 30. As a non-limiting example, the embodiment depicted in FIG. 1, the clip device 10 includes a first arm member 12 having a variable thickness heat-resistant layer 28 and a second arm member 14 having a heat-resistant layer 32 having a generally uniform thickness.

Where desired or required, the outwardly facing surface of one or both of the respective heat-resistant layers 28, 32 can cover some, or all, of the respective outer surface 18, 22 of the respective first arm member 12, second arm member 14. Where desired or required, the outer surface 18, 22 can include one or more suitable surface contours or decorative features. Non-limiting examples of suitable surface contours include fold lines and the like. In the embodiment illustrated in FIG. 1, the clip device 10 can include a suitable surface contour configured as at least one dimple such as a dimple 34 located to guide the placement of the fingers of the user.

In certain embodiments, the one or both of the heat resistant layers 28, 32 can be composed of two or more sublayers. Where one or more sublayers are employed, it is contemplated that the various sublayers can be configured and or formulated in order to enhance bonding between the associated sublayer and the heat resistant polymeric material employed in the outermost portion. associated sublayer.

One embodiment of such a configuration is depicted in FIG. 11. Where sublayers are employed, the interior sublayer 28b can be located proximate to the associated substrate layer such as substrate layer 26 while the exterior sublayer 28a can be located to define the outer surface of the respective arm member such as 12 or 14. When sublayers are configured, it is contemplated that the interior sublayer 28b will be formulated from a material that can achieve optimum connection to the associated substrate surface such as substrate layer 26 and can be one that achieves functional connection with the outer polymeric sublayer 28a. Where desired or required, the outwardly oriented surface 25 of the inner polymeric sublayer 28b can be formed with a conformal surface having contours or ridges over which the outer sublayer 28a can be positioned.

Connection between the associated substrate layer and heat resistant layer also be enhanced by the configuration of the associated substrate layer, Where desired or required, the substrate can be configured with suitable surface contours to enhance connection within the associated heat resistant layer. In the embodiment depicted in FIG. 11, the substrate layer can be configured with one or more apertures configured to receive heat resistant polymeric material therein.

The first arm member 12 and/or second arm member 14 can be configured with a pinch region 34 configured to facilitate the movement of the first arm member 12 and second arm member 14 into the open position. In the embodiment as depicted in FIGS. 1, 2, 4, and 5, at least one of the first arm member 12 and the second arm member 14 includes an extension member such as first extension member 36 and second extension member 38 respectively connected at one end of the respective first arm member 12, second arm member 14. The respective extension member 36, 38 can be integrally connected to the associated first arm member 12, 14 and project outward therefrom. Where desired or required, the one or both of the respective extension members 36, 38 can be positioned angularly relative to the associated first arm member 12, second arm member 14. In the embodiment illustrated in FIGS. 1 and 2, first extension member 36 extends angularly upward from the first arm member 12 while second extension member 38 can be essentially coplanar to the plane defined by the second arm member 14. In certain embodiments, the second extension member can be oriented angularly relative to the second arm member. The angular orientation of extension member 36 and/or second member 38 can be configured as a stop member to control or limit the opening to the maximum angle θ defined between first arm member 12 and second arm member 14 when the clip device 10 is in an open position to receive the garment articles or other fabric articles.

The pinch region P, in certain embodiments, can include a depressed area, such that grip with a finger can be facilitated. The pinch region P can, in certain embodiments, can include depression of a depth at its deepest point from between 0.1 in. to 0.3 in.

The first extension member 36 can include a substrate layer 40 that can be integral to or continuous with the substrate layer 26 of the first arm member 12 and a heat-resistant layer 44 that is contiguous with the heat resistant layer 28 associated with the first arm member 12. The second extension member 38 can include a substrate layer 42 that is integral to or continuous with the substrate layer 30 of the second arm member 14 and a heat-resistant layer 46 that is contiguous with the heat resistant layer 28 associated with the second arm member 14.

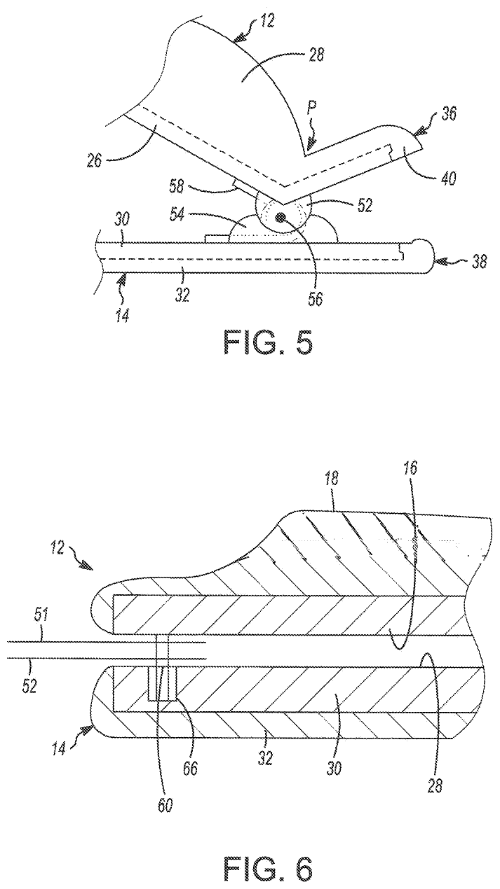

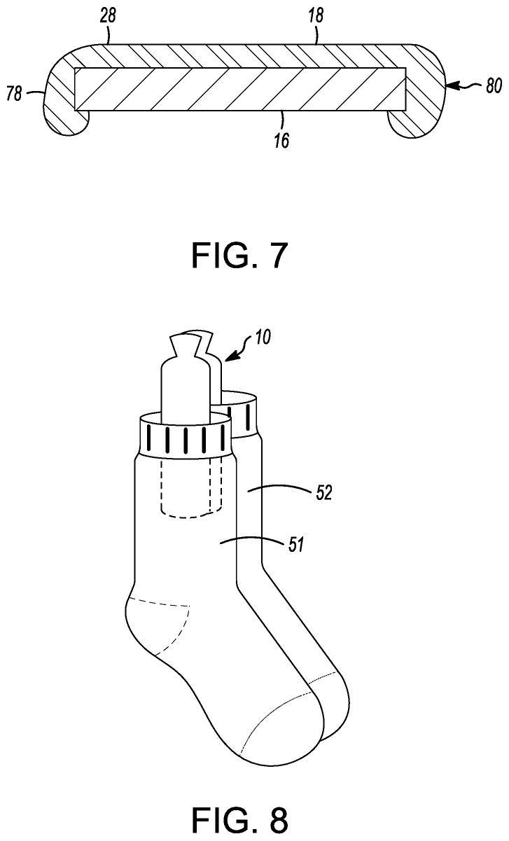

The clip device 10 can also include a pivotal attachment mechanism 50 that can be located at an inflection point such as extension point P between the first arm member 12 and the first extension member 36. Pivotal attachment mechanism 50 can be connected to and extend from the inner respective inner face 20 of the first arm member 12 and second arm member 14. In the embodiment depicted in FIG. 5, the pivotal hinge mechanism includes mating flange members 52, 54 that are held in pivotal relationship by pivot pin 56. The pivotal attachment mechanism 50 also includes biasing member 58 that is positioned relative the pivot pin 56 in a manner that biases the first arm member 12 into an open position relative to the second arm member 14 such as is illustrated in FIG. 2. The pivotal attachment mechanism 50 may include a suitable biasing means such as a spring that can be configured to bias the first and second arm members 12, 14 into an open orientation such as that depicted in FIG. 2. Where a biasing means is employed, it is contemplated that the biasing means such as a spring will exert a force of suitable strength that the respective arm members 12, 14 can be urged into overlying essentially parallel relationship by compressive force exerted by the user.

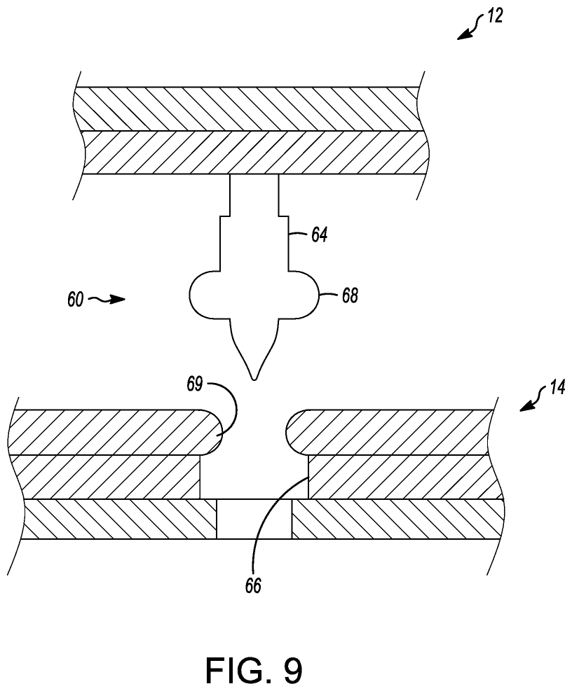

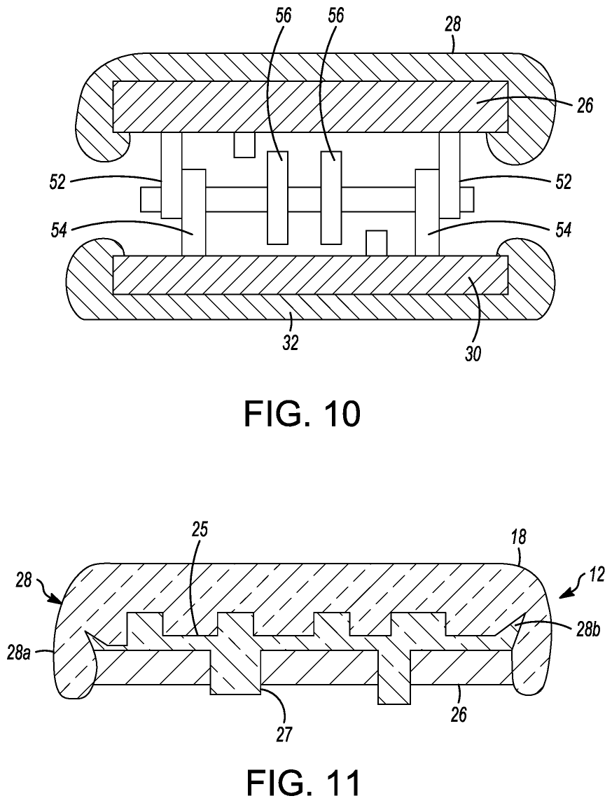

In an alternate embodiment such as that shown in FIG. 9, the pivotal attachment mechanism 50 can be covered with the heat-resistant layer 44 such that movement of the spring mechanism is thereby uninhibited. In an embodiment, the heat-resistant layer is continuous between the first arm member 12 and second arm member 14.

The first arm member 12 and second arm member 14 can be configured in a variety of suitable geometric configurations. The first arm member 12 and the second arm member 14 can have the same or similar geometric configurations, if desired or required, or can differ from one another. Non-limiting examples of suitable geometric configurations can be those that are suitable for use during machine washing and drying operations. As illustrated in FIG. 4, the second arm member 14 can be configured with a generally ovoid region having the extension member 38 projecting therefrom. Other configurations are also contemplated.

In certain embodiments, the overlying relationship between the substrate layer and the associated heat-resistant layer can be configured such that the heat resistant layer has an area that is greater than or equal to the outwardly facing surface of the associated substrate layer of the respective arm member and/or extension member. In the embodiment depicted in FIGS. 1 and 2 the heat-resistant layer extends beyond the edge of the related substrate layer to overlay and cover one or more of the edges and at least a portion of the side edges of the associated substrate. In the embodiment illustrated in FIGS. 1, 2, 3 and 9, the heat-resistant layer extends and covers each edge of the associated substrate layer to form a protective lip. Where desired or required, it is also contemplated that the heat-resistant material can extend to envelop at least a portion of the opposed surface of the associated substrate layer. A non-limiting example of such configuration is illustrated in FIG. 9 in which heat-resistant layer 28 overlays substrate member 26 and extends beyond its outwardly oriented surface to adhere to side edges 78, 80. Where desired or required, the heat-resistant layer can extend beyond and adhere to the front edge defined in the associated substrate member. Where desired or required, similar configurations can be employed in the associated extension member.

In certain embodiments as depicted in FIGS. 1 and 2, the clip device 10 can be configured such that the heat-resistant layer 28 of the first arm member 12 and the heat-resistant layer 32 of the second arm member 14 are discrete elements. However, it is considered to be within the purview of this disclosure that the respective heat-resistant layers can be joined by suitable flap members extending between the first arm member 12 and the second arm member 14 in the general region of the pivot 50. Where employed, the flap can be of a size and a shape that facilitates operational movement between the open and closed positions.

In the embodiment as illustrated in FIG. 4A, the first arm member 12 can have a first end region 70, a second end region 72 opposed to the first end region and a central region 74 interposed between the first end region 70 and the second end region 72. The first arm member 12 can have an outer periphery that includes a leading edge 76 connected to a first side edge 78 and a second side edge 80 opposed to the first side edge. Extension member 36 associated with first arm member 12 can extend from the associated second edge region 72 and can be connected to the second edge region by any suitable means. In certain embodiments, extension member 36 can be contiguously connected to the second region as a unitary member. Where desired or required, the extension member 36 can form a unitary member. Where desired or required, extension member 36 can extend angularly outward from the central region 70 at an angle other than 180°.

In the embodiment as illustrated in FIG. 4B, second arm member 14 can have a first end region 70, a second end region 72 opposed to the first end region and a central region 74 interposed between the first end region 70 and the second end region 72. The first arm member 12 can have an outer periphery that includes a leading edge 76 connected to a first side edge 78 and a second side edge 80 opposed to the first side edge, extension member 38 can be connected to the second end region 72 of the second arm member 14. Where desired or required, extension member 38 can be contiguously connected to the associated second end region of first arm member 12. Extension member 38 is connected to the associated second edge region 72 and projects outward therefrom in either an orientation coplanar with the central region 74 or one that is angularly oriented relative to the central region 74 other than 180°. A nonlimiting example of such configurations is illustrated in FIG. 4B, respectively.

The first arm member 12 and or second arm member 14 can have any suitable planar configuration. Suitable configurations comprise those that permit and facilitate use and function of the clip device 10. In the embodiment illustrated in FIGS. 1, 2, 3 and 4, the first arm member 12 and second arm member 14 can be elongated with rounded corners. Other geometric configurations include circular, ovoid and the like. In certain embodiments, the central region 74 can have a width that is greater than the dimensions of the first edge region 76 or the second edge region 78.

The clip device 10 also includes at least one prong 60 positioned on either the first arm member 12 or the second arm member 14 and projecting outward therefrom in a manner that permits removable connection with at least two fabric articles for example, articles of clothing such as a pair of socks. At least one prong 60 can be configured such that it can be removably inserted through a suitable region of the fabric articles to be clipped together by clip device 10. Suitable garments to be clipped can be composed of a fabric having a lattice that will permit piercing projection of the at least one prong 60 therethrough. Suitable fabric can be woven, non-woven or knitted material. Suitable garment articles can be garments articles such as socks and the like. The at least one prong 60 can be configured to have a suitable length and width to permit positioning of the garments in position relative to the device. In certain embodiments for example, the length of the prong can be between 0.1 inch and 1 inch, and a width ranging from 0.001 inch to 0.01 inch.

The prong 60 can be configured as an elongated rod 64 connected to either the inwardly oriented face 16 of first arm member 12 or the inwardly oriented face 20 of the second arm member 14 and projecting outward therefrom. The elongated rod 64 can have a cross section suitable to accommodate the garment articles releasably connected thereto. Non-limiting examples of suitable cross-sectional profiles include circlet ovoid, rounded rectangular, etc. The elongated rod 64 can have a width or thickness suitable to be releasably inserted through the garments to be clipped and can have a tip that is rounded or otherwise contoured to facilitate insertion. The prong 60 can be configured with suitable features to facilitate connection with a catch mechanism such as catch mechanism. Where desired or required, prong 60 can be configured with suitable catch mechanism(s) such that it can be matingly received by an associated attachment device. In certain embodiments, at least a portion of the surface of the prong 60 can be threaded. In certain embodiments, the prong 60 can have a hooked region.

The elongated rod 64 can be connected to the inwardly oriented face of either the first arm member 12 or the second arm member 14 and project angularly outward therefrom. The elongated rod 64 and associated prong 60 can be located in the clip device 10 at a position distal to the pivotal attachment mechanism 50 and the associated extension member 36, 38. The prong 60 can be matingly received in a suitable catch member defined in the opposed arm member 12, 14. The suitable catch member can include threads such that prong 60 can be releasably matingly received. The suitable catch member can include a catch such that a certain hooked embodiment of prong 60 can be matingly received for releasable attachment. In certain embodiments at least one prong 60 can be located in the first end region 70 of arm member 12.

In the embodiment depicted in FIGS. 1 and 2, prong 60 projects outward from the inwardly oriented face 16 from the first substrate member 26 at a region distal to the pivotal attachment mechanism 50. The distance between the pivotal attachment mechanism 50 and location of the prong 60 can be that sufficient to accommodate the upper cuff or outer selvage region of the garment articles to be inserted and clipped.

While the embodiments illustrated in FIGS. 1-3 illustrate a clip device 10 having a single prong 60, it is within the purview of this disclosure that the clip device 10 can be configured with two or more prongs 60. In embodiments where multiple prong members are employed, the multiple prong members can be positioned on the first arm member 12 and/or the second arm member 14 relative to one another in a manner that facilitates securing of the garment articles such as socks in position in the associated clip device 10. Non-limiting examples of such configurations can be straight lines, curved lines, and various geometric shapes.

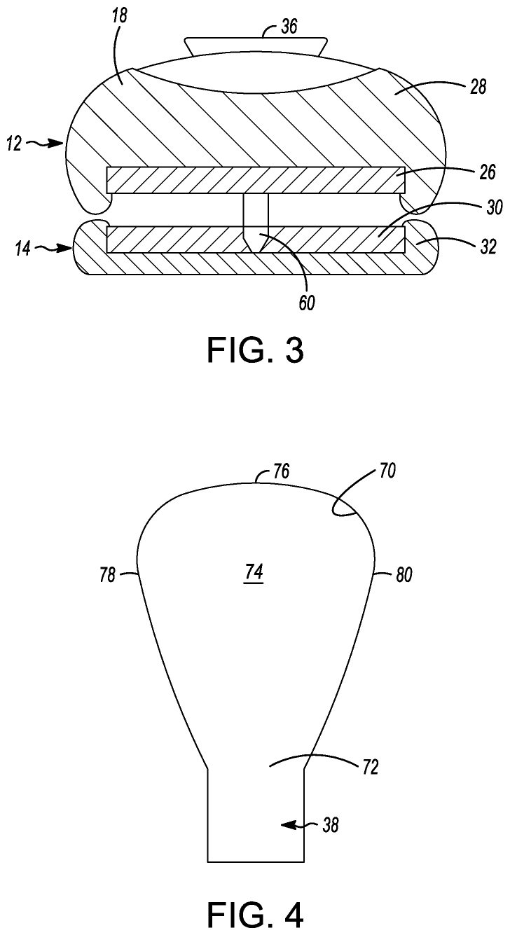

The clip device 10, as disclosed, includes a suitable mechanism for maintaining the garment articles in fixed relationship relative to the prong 60. In the embodiment as illustrated in FIGS. 2 and 3, the prong 60 projects outward from the inwardly oriented face 16 of the first arm member 12 and is releasably received in a prong receiving aperture 66 that is defined in the inwardly oriented face 20 of the second arm member 14. The prong receiving aperture 66 can be configured with a suitable closure mechanism that receives and engages a portion of prong body 64 until actively released. When engaged, the closure mechanism releasably maintains the first arm member 12 and the second arm member 14 in an orientation generally overlying and parallel to one another with the at least one prong 60 in mating releasable engaged relation with the prong receiving aperture 66.

Where desired or required, the closure mechanism 100 can be one that engages the prong 60 upon insertion and application of a closing force and opening the closure mechanism by application of a second or opening force that is applied in the same direction as the closing force to produce two stable positioned. Non-limiting examples of such mechanisms include push-push mechanisms. The prong body 64 can be configured with suitable features that can assist in the mating engagement between the prong 60 and the closure mechanism. In the embodiment depicted in FIG. 9, these are depicted as axial elements such as protrusions 66 that can defectively pass through axial shoulder(s) 69 present into the prong receiving aperture 66 upon insertion and maintain the prong 60 in position until release pressure is exerted thereon.

The prong 60 and associated closure mechanism can be located in the clip device at a position that permits effective engagement of the clip device 10 with the fabric articles to be fastened together. In the embodiment depicted in FIGS. 1 and 2, the closure mechanism is positioned at a location distal to the pivotal attachment mechanism 50 at a location where it can telescopically receive prong 60. When in use, the prong 60 can be inserted into and removably received by prong receiving aperture 66 with at least on fabric layer of two respective garments or two layers of the same garment interposed between the first arm member 12 and the second arm member 14 and impaled on the prong 60. The first arm member 12 can then be pivoted into overlying relationship with the second arm member 14 bringing the prong 60 into inserted engagement with the prong receiving aperture 66 and the closure mechanism associated therewith.

When used, the clip device 10 can be configured in the open position and a portion of the fabric of two garments such as each of a pair of socks can be inserted in the gap between the first arm member 12 and the second arm member 14 when the clip device 10 is in the open position. Once the socks are in position, the prong 60 can be pierced through the associated fabric. In the case of knitted socks, it is contemplated that the prong 60 is positioned between individual yarn members. The first arm member 12 and the second arm member 14 can be biased toward one another and the prong 60 telescopically inserted into aperture 62 and engaged the closure mechanism.

When the clip device 10 is employed with a pair of socks as when a pair of socks have been worn and will required laundering, the first arm member 12 can be inserted into the opening defined in sock S1 while second arm member 14 can be inserted into the opening defined in sock S2. The respective first arm member 12 and second arm member 14 can be inserted a sufficient distance such that the socks S1 and S2 are held in stable relationship until removal is desired.

Once the clip device 10 is in engaged relationship to the socks S1, S2, the sock and clip device unit can be placed in a laundry hamper or can be immediately laundered and subject to machine drying without the risk of the associated socks coming loose and being misplaced. The sock and clip unit can be stored until wearing or removed once laundering operations are completed.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A clip device comprising:
a first arm member and a second arm member, the first and second arm members each having an outwardly oriented face and an inwardly oriented face, the outwardly oriented face of each arm member having at least one layer of a heat-resistant polymeric material connected thereto;
a pivotal attachment mechanism, wherein the first and second arm members are connected to the pivotal attachment mechanism and project outward therefrom, wherein the pivotal attachment mechanism comprises at least one biasing member, the at least one biasing member movable between a compressed position and an extended position, wherein the first arm member and the second arm member are oriented in overlying relationship when the at least one biasing member is in the compressed position and wherein the first arm member and the second arm member are oriented in an extended position when the at least one biasing member is in the extended position;
at least one prong, the prong connected to the inwardly oriented face of at least one of the first arm member or the second arm member at a location distal to the pivotal attachment mechanism and projecting angularly outward therefrom, the at least one prong configured to removable extend through multiple layers of fabric inserted thereon; and
a closure mechanism positioned at a location distal to the pivotal attachment mechanism, the closure mechanism including at least one prong-receiving aperture defined in the second arm member, the prong-receiving aperture configured to releasably receive the at least one prong therein.

2. The clip device of claim 1 wherein at least one of the first arm member and the second arm member each has a first end region and a second end region, a first side and a second side opposed to the first side, and a central region interposed between the first end region, the second end region, the first side and the second side, wherein the central region of the at least one of the first arm member or the second arm member has a width greater than dimensions of either the first end region or the second end region.

3. The clip device of claim 2 wherein the at least one of the first arm member or the second arm member has outwardly curved side edges.

4. The clip device of claim 2 wherein the at least one layer of is in overlying relationship to the at least one of the first arm member or the second arm member.

5. The clip device of claim 4 wherein the at least one layer of the heat-resistant polymeric material is in overlying relationship to the at least one of the first arm member or the second arm member has a thickness having a value that is positionally variable relative to an associated arm member.

6. The clip device of claim 5 wherein the at least one layer of the heat-resistant polymeric material in overlying relationship to at least one of the first arm member or the second arm member has an inwardly oriented surface connected to the associated arm member and an outwardly oriented surface opposed to the inwardly oriented surface, wherein the outwardly oriented surface of the at least one layer of heat resistant polymeric material has at least one dimple defined therein.

7. The clip device of claim 1 wherein the pivotal attachment mechanism further comprises a hinge, the hinge movable between an open orientation and a closed orientation, wherein in the open orientation, the first arm member and the second arm member are oriented relative to one another and define an inner angle greater than 10°.

8. The clip device of claim 1 wherein the prong receiving aperture of the closure mechanism further comprises at least one latch mechanism defined with the prong-receiving aperture, the at least one latch mechanism configured to releasably engage the prong contained therein.

9. The clip device of claim 8 wherein the at least one prong is a cylindrical member projecting outward from the first arm member at an angle between 75° and 115°.

10. The clip device of claim 9 wherein the at least one prong is configured as a cylindrical member.

11. The clip device of claim 1 further comprising at least two layers of a fabric, the at least two layers of fabric interposed between the first arm member and the second arm member, wherein the at least two layers of fabric surround the prong.

12. The clip device of claim 11 wherein the at least two layers of the fabric are associated with at least two separate garments.

13. The clip device of claim 12 wherein the at least two layers of the fabric are associated with garments are individual socks.

14. The clip device of claim 1 wherein the at least one of the first arm member and the second arm member includes a substrate layer, wherein the substrate layer is composed of a metal.

15. The clip device of claim 14 wherein at least one of the first arm member and the second arm member is concave.

16. A clip device comprising:
a first arm member and a second arm member, the first and second arm members each having an outwardly oriented face and an inwardly oriented face, the outwardly oriented face of each arm member comprise a metal substrate layer wherein at least one layer of a heat-resistant polymeric material is connected to the arm member, wherein the first arm member and the second arm member each has first end and a second end, a first side and an opposed second side and a central region interposed between the first end, the second end, the first side and the second side, wherein the central region of the at least one of the first arm member or the second arm member has a width greater than dimensions of either the first end or the second end;
a pivotal attachment mechanism, wherein the metal substrate layer of the first and second arm members are connected to the pivotal attachment mechanism and project outward therefrom, the pivotal attachment mechanism comprises hinge members and at least one biasing member, the at least one biasing member movable between a compressed position and an extended position, wherein the first arm member and the second arm member are oriented in overlying relationship when the at least one biasing member is in the compressed position and wherein the extended position;
at least one prong, the prong connected to inwardly oriented face of at least one of the first arm member or the second arm member at a location distal to the pivotal attachment mechanism and projecting angularly outward therefrom, the at least one prong configured to removable extend through multiple layers of fabric inserted thereon; and
a closure mechanism positioned at a location distal to the pivotal attachment mechanism, the closure mechanism including at least one prong a prong-receiving aperture defined in the second arm member, the prong-receiving aperture configured to releasably receive the at least one prong therein.

17. The clip device of claim 16 wherein the first arm member and the second arm member are moveable between a first open position and second closed position and wherein the pivotal attachment mechanism further comprises a hinge, the hinge movable between an open orientation and a closed orientation, wherein in the open orientation, the first arm member and the second arm member are oriented relative to one another and define an inner angle greater than 10°.

18. The clip device of claim 1 wherein the pivotal attachment mechanism comprises a spring.
